(19) United States
(12) Patent Application Publication
(10) Pub. No.: US 2026/0202084 A1
(43) Pub. Date: Jul. 16, 2026

(54) AIR CONDITIONING SYSTEM AND METHOD

(71) Applicants: SK Innovation Co., Ltd., Seoul (KR); SK Enmove Co., Ltd., Seoul (KR)

(72) Inventors: GIHONG MIN, Daejeon (KR); INSIK JUNG, Daejeon (KR)

(21) Appl. No.: 19/445,630

(22) Filed: Jan. 12, 2026

(30) Foreign Application Priority Data
Jan. 14, 2025 (KR) 10-2025-0005449

(51) Int. Cl. F24F 11/84

(52) U.S. Cl. CPC F24F 11/84

(57) ABSTRACT

An air conditioning system configured to perform cooling by circulation of a first refrigerant may include a thermally insulated tank configured to store a second refrigerant with a specific heat higher than that of the first refrigerant; a first heat exchanger configured to perform heat exchange between the first refrigerant that is discharged from a condenser and the second refrigerant that is stored in the thermally insulated tank; and a second heat exchanger configured to perform heat exchange between the first refrigerant that is discharged by an expansion valve and the second refrigerant that is stored in the thermally insulated tank.

### CROSS-REFERENCE TO RELATED PATENT APPLICATION

This application claims the benefit of Korean Patent Application No. 10-2025-0005449, filed on January 14, 2025, the disclosure of which is incorporated herein in its entirety by reference.

### TECHNICAL FIELD

The embodiments of the present disclosure relate generally to an air conditioning system and a method of controlling the air conditioning system. The air conditioning system is capable of reducing power consumption in a peak time slot and lowering an electricity rate by indoor cooling.

### BACKGROUND

An air conditioner is a device that controls air temperature, humidity, and cleanliness to provide a fresh indoor environment. The air conditioner operates based on a cooling cycle that involves absorption and release of heat as a refrigerant circulates through a compressor, condenser, expansion valve, and evaporator.

An air conditioning system including such an air conditioner is an essential convenience device in modern life, but a fatal drawback is high power consumption that causes burden on electricity bills, strain on a power grid, and environmental impact.

In a case of a household air conditioner, an average power consumption is several kW/h, and for a large industrial and commercial system, it increases to tens of kW/h. The electricity rate thereby increase sharply depending on a duration of air conditioner operation, and the burden may be higher particularly in a peak time slot in summer.

In addition, a power peak may occur during the summer with the concentrated use of air conditioners, which may place a significant burden on the power grid and lead to a power shortage or a blackout.

### SUMMARY

### TECHNICAL PROBLEM

The embodiments of the present disclosure are directed to providing an air conditioning system capable of lowering an electricity rate by indoor cooling, and a method of controlling the air conditioning system.

In addition, the embodiments are directed to providing an air conditioning system capable of reducing power consumption in a peak time slot, and a method of controlling the air conditioning system.

In addition, the embodiments are directed to providing an air conditioning system capable of reducing an operation of a condenser in a time slot with strict noise regulations, and a method of controlling the air conditioning system.

In addition, the embodiments are directed to providing an air conditioning system capable of reducing power consumption in a peak time slot and an operation of a condenser in a peak time slot with strict noise regulations by storing a second refrigerant having a higher specific heat than those used in air conditioning systems in an insulated cooling tank when not performing indoor cooling and using the pre-cooled second refrigerant when performing indoor cooling, and a method of controlling the air conditioning system.

In addition, the embodiments are directed to providing an air conditioning system capable of determining a time slot for pre-cooling a second refrigerant such that a lower electricity rate is billed, and a method of controlling the air conditioning system.

In addition, the embodiments are directed to providing an air conditioning system capable of determining a time slot for pre-cooling a second refrigerant such that a lower electricity rate is billed without violating noise regulation standards according to places where the air conditioning system is located, and a method of controlling the air conditioning system.

In addition, the embodiments are directed to providing an air conditioning system capable of determining a time slot for pre-cooling a second refrigerant such that a lower electricity rate is billed by using a pre-trained AI model by considering weather forecasts and noise regulation standards, and a method of controlling the air conditioning system.

### TECHNICAL SOLUTION

An air conditioning system configured to perform cooling by circulation of a first refrigerant according to an embodiment of the present disclosure may include an thermally insulated tank configured to store a second refrigerant with a specific heat higher than that of the first refrigerant; a first heat exchanger configured to exchange heat between the first refrigerant that is discharged by a condenser and the second refrigerant that is stored in the thermally insulated tank; and a second heat exchanger configured to perform heat exchange between the first refrigerant that is discharged by an expansion valve and the second refrigerant that is stored in the thermally insulated tank

In addition, the first heat exchanger may be configured to deliver the first refrigerant that is cooled by the second refrigerant to the expansion valve.

In addition, the second heat exchanger may be configured to deliver the second refrigerant that is cooled by the first refrigerant to the thermally insulated tank and to deliver the first refrigerant of which the temperature has increased, to a compressor.

In addition, the air conditioning system may further include at least one heat dissipation plate attached or connected to one side surface of the thermally insulated tank and configured to discharge heat of the thermally insulated tank to the outside.

In addition, the air conditioning system may further include a first flow path having one end connected to the condenser and configured to receive the first refrigerant from the condenser; a second flow path having one end connected to the first heat exchanger and configured to deliver the first refrigerant to the first heat exchanger when receiving the first refrigerant from the first flow path; and a third flow path having one end connected to the expansion valve and configured to deliver the first refrigerant to the expansion valve when receiving the first refrigerant from the first flow path.

In addition, the air conditioning system may further include a first valve which is connected to one end of the first flow path, one end of the second flow path, and one end of the third flow path, and configured to deliver the first refrigerant received from the first flow path to one of the second flow path and the third flow path.

In addition, the air conditioning system may further include a fourth flow path having one end connected to the expansion valve and configured to receive the first refrigerant from the expansion valve; a fifth flow path having one end connected to the second heat exchanger and configured to deliver the first refrigerant to the second heat exchanger when receiving the first refrigerant from the fourth flow path; and a sixth flow path having one end connected to an evaporator and configured to deliver the first refrigerant to the evaporator when receiving the first refrigerant from the fourth flow path.

In addition, the air conditioning system may further include a second valve which is connected to one end of the fourth flow path, one end of the fifth flow path, and one end of the sixth flow path, and configured to deliver the first refrigerant received from the fourth flow path to one of the fifth flow path and the sixth flow path.

In addition, the air conditioning system may further include a processor configured to control opening and closing of the first valve and opening and closing of the second valve, wherein the processor may be configured to control the opening and closing of the first valve such that the first refrigerant of the first flow path is delivered to one of the first heat exchanger and the expansion valve; and to control the opening and closing of the second valve such that the first refrigerant of the fourth flow path is delivered to one of the second heat exchanger and the evaporator.

In addition, the processor may be configured to control the opening and closing of the first valve such that the first refrigerant of the first flow path is delivered to the expansion valve when a state of the air conditioning system is in a second refrigerant cooling mode, to control the opening and closing of the second valve such that the first refrigerant of the fourth flow path is delivered to the second heat exchanger when the state of the air conditioning system is in the second refrigerant cooling mode, to control the opening and closing of the first valve such that the first refrigerant of the first flow path is delivered to the first heat exchanger when the state of the air conditioning system is in an indoor cooling mode, and to control the opening and closing of the second valve such that the first refrigerant of the fourth flow path is delivered to the evaporator when the state of the air conditioning system is in the indoor cooling mode.

In addition, the air conditioning system may further include an input module configured to receive a user command, wherein the processor may be configured to set the state of the air conditioning system to the second refrigerant cooling mode when the input module receives a second refrigerant cooling command indicating to cool the second refrigerant.

In addition, the air conditioning system may further include an input module configured to receive a user command, wherein the processor may be configured to change the state of the air conditioning system to the indoor cooling mode when the input module receives an indoor cooling command indicating to cool the indoor space while the state of the air conditioning system is in the second refrigerant cooling mode.

In addition, the processor may be configured to set the state of the air conditioning system to the second refrigerant cooling mode when a current time is between a first time, which is one time of a day, and a second time, which is later than the first time.

In addition, the air conditioning system may further include a data reception module configured to receive time-based electricity rate data including information on electricity rates depending on time slots of the day from a power supply company server, wherein the processor may be configured to determine the first time and the second time based on the time-based electricity rate data.

In addition, the processor may be configured to determine, based on the time-based electricity rate data, the first time as a time at which a lowest rate time slot, in which a lowest electricity rate of a day is charged, starts, and to determine the second time as a time at which the lowest rate time slot ends, and when the data reception module receives updated time-based electricity rate data, to change the first time to a time at which an updated lowest rate time slot starts and to change the second time to a time at which the updated lowest rate time slot ends based on the updated time-based electricity rate data.

In addition, the processor may be configured to determine whether the electricity rate for a current time is less than a preset reference rate based on the time-based electricity rate data, and to set a state of the air conditioning system to a second refrigerant cooling mode when the electricity rate for the current time is less than the reference rate.

In addition, the data reception module may be configured to receive time-based noise regulation information which includes information on noise regulation standards according to time slots of a day and the noise regulation standards according to regions from a public institution server, wherein the processor may be configured to determine the first time and the second time based on location information which is information on a region where the air conditioning system is installed, the time-based electricity rate data, and the time-based noise regulation information.

In addition, the processor may be configured to determine, based on the time-based electricity rate data and the time-based noise regulation information, the first time as a time at which the noise regulation ends during a day among times included in a lowest rate time slot in which the lowest electricity rate of a day is charged.

In addition, the data reception module may be configured to receive weather forecast information, which is prediction information on weather, from a weather forecast server, and the processor may be configured to determine the first time and the second time using an artificial intelligence model based on the time-based electricity rate data, the time-based noise regulation information, and the weather forecast information, and may further include a machine learning module configured to train an artificial intelligence model through a machine learning method by setting learning electricity rate data, learning time-based noise regulation information, and learning weather record information for a learning period among past periods as input variables, and by setting information on a learning first time and information on a learning second time that are set during the learning period as output variables.

A method of controlling an air conditioning system to control the air conditioning system according to an embodiment of the present disclosure may include controlling, by the processor, the opening and closing of the first valve such that the first refrigerant of the first flow path is delivered to one of the first heat exchanger and the expansion valve; and controlling, by the processor, the opening and closing of the second valve such that the first refrigerant of the fourth flow path is delivered to one of the second heat exchanger and the evaporator, wherein the controlling of the opening and closing of the first valve and the controlling of the opening and closing of the second valve may include controlling, by the processor, the opening and closing of the first valve such that the first refrigerant of the first flow path is delivered to the expansion valve when a state of the air conditioning system is in a second refrigerant cooling mode; controlling, by the processor, the opening and closing of the second valve such that the first refrigerant of the fourth flow path is delivered to the second heat exchanger when the state of the air conditioning system is in the second refrigerant cooling mode; controlling, by the processor, the opening and closing of the first valve such that the first refrigerant of the first flow path is delivered to the first heat exchanger when the state of the air conditioning system is in an indoor cooling mode; and controlling, by the processor, the opening and closing of the second valve such that the first refrigerant of the fourth flow path is delivered to the evaporator when the state of the air conditioning system is in the indoor cooling mode.

### ADVANTAGEOUS EFFECTS

According to the embodiments of the present disclosure, it is possible to lower an electricity rate by indoor cooling.

According to another embodiment of the present disclosure, it is possible to reduce power consumption in a peak time slot.

According to another embodiment of the present disclosure, it is possible to reduce an operation of a condenser in a time slot with strict noise regulations.

According to another embodiment of the present disclosure, it is possible to reduce power consumption in a peak time slot and an operation of a condenser in a peak time slot with strict noise regulations by storing a second refrigerant having a higher specific heat than those used in air conditioning systems in an insulated cooling tank when not performing indoor cooling and using the pre-cooled second refrigerant when performing indoor cooling.

According to another embodiment of the present disclosure, it is possible to determine a time slot for pre-cooling the second refrigerant such that a lower electricity rate is billed.

According to another embodiment of the present disclosure, it is possible to determine a time slot for pre-cooling the second refrigerant such that a lower electricity rate is billed without violating noise regulation standards according to places where the air conditioning system is located.

According to another embodiment of the present disclosure, it is possible to determine a time slot for pre-cooling the second refrigerant such that a lower electricity rate is billed by using a pre-trained AI model by considering weather forecasts and noise regulation standards.

### BRIEF DESCRIPTION OF THE DRAWINGS

FIG. 1 is a view showing a configuration of an air conditioning system according to an embodiment of the present disclosure.

FIG. 2 is a view showing a configuration of an air conditioning system including a heat dissipation plate according to an embodiment of the present disclosure.

FIG. 3 is a view for describing an operation of an air conditioning system of which a state is in an indoor cooling mode according to an embodiment of the present disclosure.

FIG. 4 is a view for describing an operation of an air conditioning system of which a state is in a second refrigerant cooling mode according to an embodiment of the present disclosure.

FIG. 5 is a control block diagram of an air conditioning system according to an embodiment of the present disclosure.

FIG. 6 is a flowchart of a method of controlling an air conditioning system according to an embodiment of the present disclosure.

FIG. 7 is a flowchart of a method of controlling an air conditioning system for determining a time slot to be set to a second refrigerant cooling mode according to an embodiment of the present disclosure.

FIG. 8 is a flowchart of a method of controlling an air conditioning system for determining a time slot to be set to a second refrigerant cooling mode using an AI model according to an embodiment of the present disclosure.

### DETAILED DESCRIPTION

The same reference numerals refer to the same components throughout the specification. This specification does not describe all elements of the embodiments, and contents that are general in the technical field to which the disclosed embodiments belong or that overlap between the embodiments are omitted.

As used herein, the term 'electricity rate' refers to the price per unit of electrical energy charged by a utility provider, which may vary based on a predetermined schedule or real-time demand signals (e.g., Time-of-Use (TOU) pricing or peak/off-peak billing cycles). The system determines a 'lower' electricity rate by identifying time slots where the unit price is reduced relative to other available time slots.

As used herein, the term “module” refers to a unit that processes at least one function or operation and may refer to, for example, software, a field-programmable gate array (FPGA), or a hardware component. The functions provided in the “module” may be performed separately by a plurality of components or may be integrated with other additional components. The “module” in this specification is not necessarily limited to software or hardware, and may be configured to reside on an addressable storage medium, and may be configured to boot one or more processors

When an element of an embodiment is “connected” to another element, this includes not only a case of a direct connection, but also a case of an indirect connection in which still another element is present between the element and the another element.

In addition, when an element is said to “include” a component, this does not mean that it excludes other components, but rather that it may include other components, unless otherwise specifically described.

The terms “first”, “second”, etc. are used to distinguish one component from another, and the components are not limited by the aforementioned terms.

Singular expressions include plural expressions unless the context clearly indicates otherwise.

Reference numerals used for method operations are just used for convenience of description, and not to limit an order of the operations. Thus, unless the context clearly dictates otherwise, the written order may be practiced otherwise.

Hereinafter, the operating principle and embodiments of the present disclosure will be described with reference to the attached drawings.

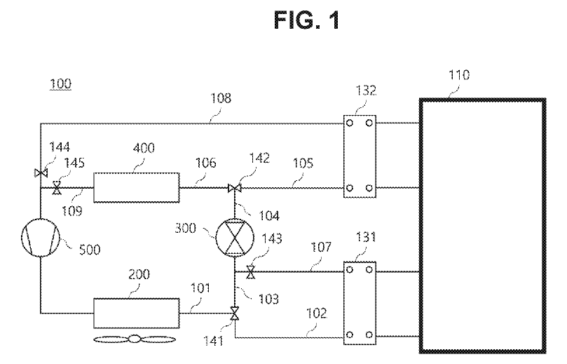

FIG. 1 is a view showing a configuration of an air conditioning system according to an embodiment of the present disclosure.

Referring to FIG. 1, an air conditioning system 100 may include a first flow path 101, second flow path 102, third flow path 103, fourth flow path 104, fifth flow path 105, sixth flow path 106, seventh flow path 107, eighth flow path 108, ninth flow path 109, thermally insulated tank 110 (also referred to as a thermal storage tank), first heat exchanger 131, second heat exchanger 132, first valve 141, second valve 142, third valve 143, fourth valve 144, and fifth valve 145. The air conditioning system 100 may further include evaporator 400, compressor 500, condenser 200, and expansion valve 300.

The air conditioning system 100 may be an air handling system that performs indoor cooling of a building. The air conditioning system 100 may be configured to perform cooling by circulation of a first refrigerant.

The first refrigerant may be a conventional refrigerant, such as chlorofluorocarbons (CFCs) or hydrochlorofluorocarbons (HCFCs), or a refrigerant, such as hydrofluorocarbons (HFCs). Furthermore, the first refrigerant may be an environmentally friendly refrigerant, such as R-32 (Difluoromethane) or R-290 (Propane), but the type of first refrigerant is not limited thereto.

In this case, the first refrigerant may absorb and release heat while circulating the condenser 200, expansion valve 300, evaporator 400, and compressor 500 provided in the air conditioning system 100.

The first refrigerant of which temperature has increased while passing through the evaporator 400 and the compressor 500 in sequence, may be delivered to the expansion valve 300 after its temperature has decreased in the condenser 200. The temperature of the first refrigerant that is delivered to the evaporator 400 again while passing through the expansion valve 300 may decrease.

In this case, when the first refrigerant delivered from the condenser 200 to the expansion valve 300 is first cooled through heat exchange with the second refrigerant that has been cooled in advance as a refrigerant separate from the first refrigerant and then delivered to the expansion valve 300, the energy or power required for cooling may be reduced compared to a case in which the second refrigerant is not used.

That is, when the first refrigerant is first cooled through heat exchange with the second refrigerant that has been cooled in advance and then delivered to the expansion valve 300, the operation of the condenser 200 and the operation of a fan included in the condenser 200 may be reduced, thereby reducing the energy required for cooling as well as noise due to driving of the fan.

The thermally insulated tank 110 (also referred to as a thermal storage tank) may be configured to store the second refrigerant. The thermally insulated tank 110 may comprise a thermally resistive structure and materials having high thermal-insulating properties configured to minimize heat transfer from an ambient environment to the second refrigerant that is stored in the thermally insulated tank 110. For example, the thermally insulated tank 110 may be configured with a double housing structure, the second refrigerant is stored in an inner housing, and a space between the inner housing and an outer housing may be a vacuum or a structure filled with an insulating material, but the structure of the thermally insulated tank 110 is not limited thereto.

The first heat exchanger 131 may be configured to perform heat exchange between the first refrigerant that is discharged from the condenser 200 and the second refrigerant that is stored in the thermally insulated tank 110.

The second heat exchanger 132 may be configured to perform heat exchange between the first refrigerant that is discharged from the expansion valve 300 and the second refrigerant that is stored in the thermally insulated tank 110.

The first heat exchanger 131 and the second heat exchanger 132 may be plate-type heat exchangers configured to perform heat exchange for two types of fluids, but the type of each heat exchanger is not limited thereto.

The first heat exchanger 131 may be configured to deliver the first refrigerant that is cooled by the second refrigerant to the expansion valve 300.

The second heat exchanger 132 may be configured to deliver the second refrigerant that is cooled by the first refrigerant to the thermally insulated tank 110 and to deliver the first refrigerant with the temperature increased to the compressor 500.

The second refrigerant may be a refrigerant with a higher specific heat than that of the first refrigerant. For example, the second refrigerant may be water, but it is not limited thereto. Since the second refrigerant is the refrigerant with a higher specific heat, a difference in heat capacity for a same temperature difference may be greater than that of the first refrigerant.

The air conditioning system 100 according to an embodiment may cool the second refrigerant in advance by circulation of the first refrigerant in a time slot in which electricity rates are high or noise regulations are in effect.

In a case that a user wants indoor cooling after the second refrigerant is cooled, the second refrigerant having a high specific heat contributes to the temperature drop of the first refrigerant through heat exchange in the performing of cooling of the first refrigerant while circulating the first refrigerant, so that the air conditioning system 100 according to one embodiment may reduce the operation of the condenser 200 and compressor 500 and thus reduce power consumption compared to a case where the second refrigerant is not used.

When a time slot in which the user wants indoor cooling is a time slot with peak electricity rate, excessive electricity charges will be charged for conventional types of air conditioning devices due to the nature of electricity rates.

Moreover, since the air conditioning system 100 according to an embodiment contributes to cooling of the first refrigerant by using the second refrigerant that is pre-cooled in a time slot in which the electricity rate is relatively low, even when the user uses indoor cooling with the air conditioning system 100 in the time slot with peak electricity rate or a period in which a more higher rate is billed such as summer, the user uses relatively less electricity and may reduce the electricity rate by reducing a significant portion of the electricity rate that would be applied in the peak time slot. That is, the air conditioning system minimizes peak-load energy expenses by leveraging a pre-cooled secondary refrigerant to offset cooling requirements during high-tariff periods.

The second refrigerant that is pre-cooled by the first refrigerant and stored in the thermally insulated tank 110 may have a temperature lower than the ambient temperature, but the second refrigerant that is stored in the thermally insulated tank 110 may not necessarily have a temperature lower than the ambient temperature. That is, the second refrigerant that is stored in the thermally insulated tank 110 may have a temperature higher than the ambient temperature even though it is lower than the first refrigerant that is discharged from the condenser 200 in the performing of the indoor cooling. In this case, a method of pre-cooling the second refrigerant through heat exchange with the ambient air may also be possible.

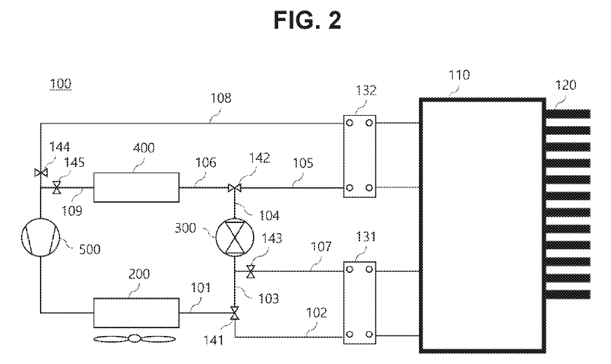

FIG. 2 is a view showing a configuration of an air conditioning system including a heat dissipation plate according to an embodiment of the present disclosure.

Referring to FIG. 2, the air conditioning system 100 may further include at least one heat dissipation plate 120.

The heat dissipation plate 120 may be connected to an outer side surface of the thermally insulated tank 110. Alternatively, the heat dissipation plate 120 may be attached to one side surface of the thermally insulated tank 110. In this case, each heat dissipation plate 120 may be attached and detached to and from one side surface of the thermally insulated tank 110, but it is not limited thereto. The heat dissipation plate 120 may be configured to be exposed to the exterior of the building in which the air conditioning system 100 is installed, but it is not limited thereto. For example, the heat dissipation plate 120 may be configured to be exposed to the interior of the building. The heat dissipation plate 120 may be configured to release heat of the thermally insulated tank 110 to the outside of the thermally insulated tank 110.

As such, the second refrigerant that is stored inside the thermally insulated tank 110 may be pre-cooled before the indoor cooling by heat exchange with the ambient air by the heat dissipation plate 120.

Referring to FIGS. 1 and 2, the first flow path 101 may have one end connected to the condenser 200 and may be configured to receive the first refrigerant from the condenser 200.

The second flow path 102 may have one end connected to the first heat exchanger 131. The second flow path 102 may be configured to receive the first refrigerant from the first flow path 101 and deliver the first refrigerant to the first heat exchanger 131.

The third flow path 103 may have one end connected to the expansion valve 300. The third flow path 103 may be configured to deliver the first refrigerant to the expansion valve 300 when receiving the first refrigerant from the first flow path 101.

The fourth flow path 104 may have one end connected to an expansion valve 300. The fourth flow path 104 may be configured to receive the first refrigerant from the expansion valve 300.

The fifth flow path 105 may have one end connected to the second heat exchanger 132. The fifth flow path 105 may be configured to deliver the first refrigerant to the second heat exchanger 132 when receiving the first refrigerant from the fourth flow path 104.

The sixth flow path 106 may have one end connected to the evaporator 400. The sixth flow path 106 may be configured to deliver the first refrigerant to the evaporator 400 when receiving the first refrigerant from the fourth flow path 104.

The seventh flow path 107 may have one end connected to the first heat exchanger 131 and the other end connected to a third connecting flow path. The seventh flow path 107 may deliver the first refrigerant to the third flow path 103 such that the first refrigerant is delivered to the expansion valve 300 when receiving the first refrigerant from the heat exchanger 131.

The eighth flow path 108 may have one end connected to the second heat exchanger 132 and the other end connected to a ninth connecting flow path. The eighth flow path 108 may deliver the first refrigerant to the ninth flow path 109 such that the first refrigerant is delivered to the compressor 500 when receiving the first refrigerant from the second heat exchanger 132.

The ninth flow path 109 may have one end connected to the evaporator 400 and the other end connected to the compressor 500. The ninth flow path 109 may deliver the first refrigerant to the compressor 500 when receiving the first refrigerant from the evaporator 400 or the eighth flow path 108.

The first valve 141 may be connected to one end of the first flow path 101, one end of the second flow path 102, and one end of the third flow path 103. The first valve 141 may deliver the first refrigerant received from the first flow path 101 to one of the second flow path 102 or the third flow path 103.

The second valve 142 may be connected to one end of the fourth flow path 104, one end of the fifth flow path 105, and one end of the sixth flow path 106. The second valve 142 may deliver the first refrigerant received from the fourth flow path 104 to one of the fifth flow path 105 or the sixth flow path 106.

The first valve 141 and the second valve 142 may be valves used to control the flow of fluid or change direction and may be 3-WAY valves that have three ports with an ability to control the direction in which the fluid flows by the processor 150.

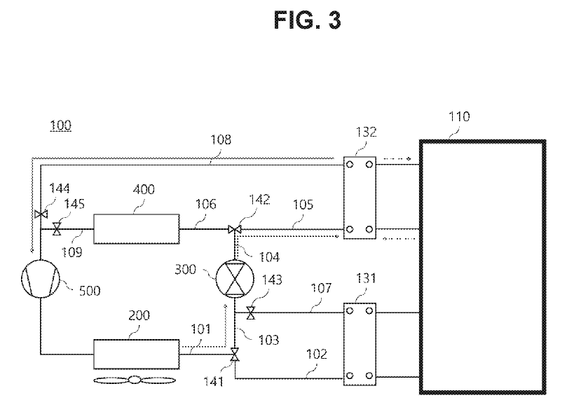

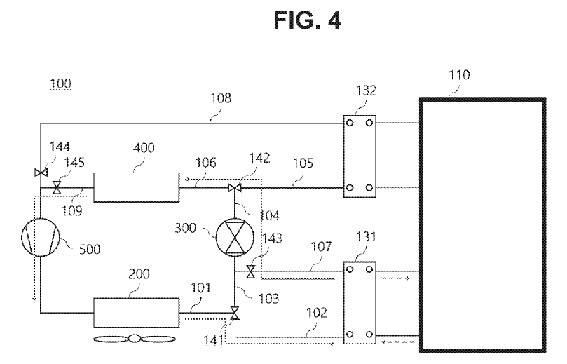

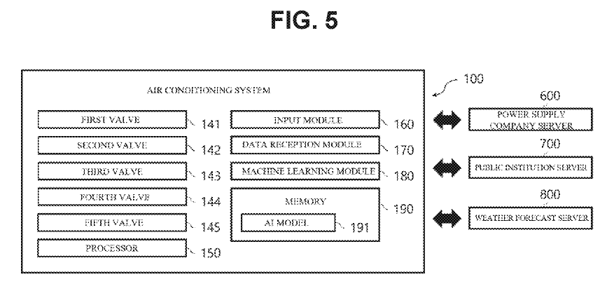

FIG. 3 is a view for describing an operation of an air conditioning system of which a state is in an indoor cooling mode according to an embodiment of the present disclosure, FIG. 4 is a view for describing an operation of an air conditioning system of which a state is in a second refrigerant cooling mode according to an embodiment of the present disclosure, and FIG. 5 is a control block diagram of an air conditioning system according to an embodiment of the present disclosure.

Referring to FIGS. 3, 4, and 5, the air conditioning system 100 may include a processor 150, input module 160, data reception module 170, machine learning module 180, memory 190, and first to fifth valves 141 to 145.

The processor 150 may control the opening and closing of the first valve 141 and the opening and closing of the second valve 142.

The processor 150 may control the opening and closing of the first valve 141 such that the first refrigerant of the first flow path 101 is delivered to one of the first heat exchanger 131 and the expansion valve 300.

The processor 150 may control the opening and closing of the second valve 142 such that the first refrigerant of the fourth flow path 104 is delivered to one of the second heat exchanger 132 and the evaporator 400.

The third valve 143 may be provided on the seventh flow path 107. When the first valve 141 is controlled to deliver the first refrigerant to the second flow path 102, the processor 150 may control the opening and closing of the third valve 143 so that the third valve 143 opens the seventh flow path 107. When the first valve 141 is controlled to deliver the first refrigerant to the third flow path 103, the processor 150 may control the opening and closing of the third valve 143 so that the third valve 143 closes the seventh flow path 107.

The fourth valve 144 may be provided on the eighth flow path 108. When the second valve 142 is controlled to deliver the first refrigerant to the fifth flow path 105, the processor 150 may control the opening and closing of the fourth valve 144 so that the fourth valve 144 opens the eighth flow path 108. When the second valve 142 is controlled to deliver

the first refrigerant to the sixth flow path 106, the processor 150 may control the opening and closing of the fourth valve 144 so that the fourth valve 144 closes the eighth flow path 108.

The fifth valve 145 may be provided on the ninth flow path 109. When the second valve 142 is controlled to deliver the first refrigerant to the sixth flow path 106, the processor 150 may control the opening and closing of the fifth valve 145 so that the fifth valve 145 opens the ninth flow path 109. When the second valve 142 is controlled to deliver the first refrigerant to the fifth flow path 105, the processor 150 may control the opening and closing of the fourth valve 144 so that the fifth valve 145 closes the ninth flow path 109.

The state of the air conditioning system 100 may be set to one of a second refrigerant cooling mode or an indoor cooling mode, but the state of the air conditioning system 100 is not limited thereto. For example, the state of the air conditioning system 100 may be a stop mode in which operation is completely stopped.

The second refrigerant cooling mode may be a mode in which the second refrigerant is pre-cooled in a situation in which the indoor cooling is not performed. The state of the air conditioning system 100 may be set to the second refrigerant cooling mode in a time slot in which relatively low electricity rates are charged or noise regulations are in effect.

The indoor cooling mode may be a mode in which indoor cooling is performed using a pre-cooled second refrigerant. When a user inputs a command to perform indoor cooling through the input module 160, such as a remote control for the air handling system, the state of the air conditioning system 100 may be immediately set to the indoor cooling mode, regardless of whether it was in the second refrigerant cooling mode or the stop mode.

When the state of the air conditioning system 100 is in the second refrigerant cooling mode, the processor 150 may control the opening and closing of the first valve 141 such that the first refrigerant of the first flow path 101 is delivered to the expansion valve 300.

When the state of the air conditioning system 100 is in the second refrigerant cooling mode, the processor 150 may control the opening and closing of the second valve 142 such that the first refrigerant of the fourth flow path 104 is delivered to the second heat exchanger 132.

When the state of the air conditioning system 100 is in the indoor cooling mode, the processor 150 may control the opening and closing of the first valve 141 such that the first refrigerant of the first flow path 101 is delivered to the first heat exchanger 131.

When the state of the air conditioning system 100 is in the indoor cooling mode, the processor 150 may control the opening and closing of the second valve 142 such that the first refrigerant of the fourth flow path 104 is delivered to the evaporator 400.

The input module 160 may be configured to receive a user command. The input module 160 may be a touch input device or a button that is directly provided on an air handling device included in the air conditioning system 100, but it is not limited thereto. For example, the input module 160 may be a remote control that transmits the user command as a signal to the air conditioning system 100.

A user who wants to cool the second refrigerant may input a second refrigerant cooling command indicating to cool the second refrigerant to the input module 160.

When the input module 160 receives the second refrigerant cooling command, the processor 150 may set the state of the air conditioning system 100 to the second refrigerant cooling mode.

When the user wants indoor cooling in the second refrigerant cooling mode in the air conditioning system 100, it is necessary to change the state of the air conditioning system 100 to immediately stop cooling the second refrigerant by the first refrigerant and to perform cooling of the first refrigerant using the second refrigerant.

A user who wants indoor cooling may input an indoor cooling command indicating to cool the indoor space into the input module 160.

When the input module 160 receives the indoor cooling command while the state of the air conditioning system 100 is in the second refrigerant cooling mode, the processor 150 may change the state of the air conditioning system 100 to the indoor cooling mode.

The state of the air conditioning system 100 may be automatically set according to a current time. Accordingly, the air conditioning system 100 may cool the second refrigerant in advance in a time slot in which relatively low rates are billed.

A first time may be any time of day. For example, the first time may be 10:00 PM, at which a time slot in which the lowest rate is charged starts, but it is not limited thereto.

A second time may be any time of day that is later than the first time. For example, the second time may be 10:00 AM, at which a time slot in which the lowest rate is charged ends. In this case, the first time may be 10:00 PM, and the second time may be 10:00 AM a day after when first time is set, but the first and second times are not limited thereto.

The processor 150 may determine whether the current time is between the first time, which is any time of a day, and the second time, which is later than the first time.

When the current time is between the first time, which is any time of a day, and the second time, which is later than the first time, the processor 150 may set the state of the air conditioning system 100 to the second refrigerant cooling mode.

For example, when the first time is set to 10:00 PM and the second time is set to 10:00 AM while the current time is 11:00 PM, the processor 150 may set the state of the air conditioning system 100 to the second refrigerant cooling mode.

The data reception module 170 may be a communication module that performs wired or wireless communication with other servers and terminals. The data reception module 170 may transmit received data to the processor 150.

The data reception module 170 may receive time-based electricity rate data from a power supply company server 600.

The power supply company server 600 may be a server operated, for example, by Korea Electric Power Corporation, (or some other US based power corporation) which is an entity that supplies power, or Korea Power Exchange, but it is not limited thereto.

The time-based electricity rate data may include information on the electricity rates based on time slots of a day.

Electricity rates may be differently set depending on the time slots of a day. The time-based electricity rates thus set are not always consistent, but they may vary by day or season and may be revised and updated.

For example, household electricity rates in the country (such as, for example, US, or Korea) may vary depending on time-based rates and monthly rates.

Specifically, electricity rates in the country (e.g. US, Korea etc.) are applied differently based on time slots. This means that rates vary depending on the time slots of 24 hours a day in which the electricity is used. Typically, rates are higher in time slots with high electricity demand. In this case, a "seasonal time-based rate" system is typically applied, which may include the following time slot classification.

A basic time slot (Off-Peak) may usually be a late-night time slot (10:00 PM to 8:00 AM the next day), a normal time slot (Normal) may be a typical time slot of a day (8:00 AM to 6:00 PM), and a peak time slot (Peak) may be a time slot with high power consumption (6:00 PM to 10:00 PM), but the time slots are not limited thereto.

For example, as for the above-described time-based rate system for residential electricity rates, the electricity rates of the Korea Electric Power Corporation or a US power company may be set differently for each time slot and may be divided into three time slots as described below.

The basic time slots may be between 10:00 PM and 9:00 AM the next day and between 10:00 AM and 3:00 PM, the regular time slots are from 9:00 AM to 10:00 AM, from 3:00 PM to 5:00 PM, and from 8:00 PM to 10:00 PM, and the peak time slot, which may be the time slot in which the most electricity is used at home, may be from 5:00 PM to 8:00 PM. In this case, electricity rates are charged differently for each time slot, and the rate for the peak time slot may be the most expensive.

For example, there is a fixed rate in the electricity rate that is charged when there is no usage, and it may be divided into three stages. Usage-based rates may include stage 1 for 0-200 kWh (charged according to the basic rate), stage 2 for 200-400 kWh (higher rate than stage 1), and stage 3 for 400 kWh or higher (highest rate).

An illustration of an approximate rate billed thereby may be approximately 60-80 won/kWh in the basic time slot (late night), approximately 120-150 won/kWh in the regular time slot (mid-day), and approximately 200-250 won/kWh in the peak time slot. In addition, since a progressive rate system is applied, the higher the monthly usage, the more rapidly the rate increases. For example, when using less than 200 kWh, the rate may be relatively cheap, but when using more than 400 kWh, a high rate may be charged.

In another embodiment of an approximate rate billed thereby may be approximately 5-7 cents/kWh in the basic time slot (late night), approximately 10-12 cents/kWh in the regular time slot (mid-day), and approximately 16-20 cents/kWh in the peak time slot. In addition, since a progressive rate system is applied, the higher the monthly usage, the more rapidly the rate increases. For example, when using less than 200 kWh, the rate may be relatively cheap, but when using more than 400 kWh, a high rate may be charged.

Therefore, considering this electricity rate billing method, using less electricity in the peak time slot may save electricity rates for the users. However, the users are also likely to want indoor cooling in the peak time slot.

In this case, the air conditioning system 100 according to one embodiment may automatically determine a time slot in which the state of the air conditioning system 100 changes based on the time-based electricity rate data including information on the electricity rate billing method by pre-cooling the second refrigerant in a time slot in which a relatively low cost is billed and contributing to cooling of the first refrigerant using the second refrigerant in the peak time slot to reduce power consumption in the peak time slot.

The processor 150 may determine the first time and the second time based on the time-based electricity rate data.

The processor 150 may determine, based on the time-based electricity rate data, the first time as a time at which the lowest rate time slot, in which a lowest electricity rate of a day is charged, starts, and determine the second time as a time at which the lowest rate time slot ends.

For example, when the time-based electricity rate data includes information that the approximate rate billed by each time slot is approximately 60-80 won/kWh (or 5-7 cents/kWh) for the basic time slot (late night), approximately 120-150 won (or 8.3 – 10.4 cents/kWh) for the normal time slot (mid-day), and approximately 200-250 won/kWh (or 13.8 – 17.3 cents/kWh) for the peak time slot, wherein the basic time slot (Off-Peak) is from 10:00 PM to 8:00 AM the next day, the normal time slot (Normal) is from 8:00 AM to 6:00 PM of a day, and the peak time slot (Peak) is from 6:00 PM to 10:00 PM,

For example, the processor 150 may determine 10:00 PM, the time at which the basic time slot, which is the lowest rate time slot, starts, as the first time, and 8:00 AM the next day, the time at which the basic time slot ends, as the second time.

If the time-based electricity rate data is revised due to seasonal factors or other artificial factors, the air conditioning system 100 may re-set the first time and the second time in consideration of the changed billing system.

When the data reception module 170 receives updated time-based electricity rate data, the processor 150 may change the first time to a time at which an updated lowest rate time slot starts and change the second time to a time at which the updated lowest rate time slot ends based on the updated time-based electricity rate data.

The method of setting the mode of the air conditioning system 100 may be set not by setting the time at which each mode is set, but by whether the electricity rate to be billed at the current time exceeds a certain criterion.

The processor 150 may determine, based on the time-based electricity rate data, whether the electricity rate for a current time is below a preset reference rate. The reference rate may be preset by a user.

When the electricity rate for current time is less than the reference rate, the processor 150 may set the state of the air conditioning system 100 to the second refrigerant cooling mode.

For example, when the reference rate is set to 100 won/kWh (or 6.9 cents/kWh) and the electricity rate for the current time is 80 won/kWh (or 5.5 cents/kWh), the processor 150 may set the state of the air conditioning system 100 to the second refrigerant cooling mode.

Moreover, the air conditioning system 100 may also change its state based on noise regulations as well as electricity rates. A typical air handling system may generate significant noise due to operation of an outdoor unit, etc. It may be preferable to pre-operate the outdoor unit at a time with minimal noise regulations to cool the second refrigerant, and cool the first refrigerant using the second refrigerant during periods with strict noise regulations to reduce the operation of the outdoor unit.

A public institution server 700 may store time-based noise regulation information including information on time-based noise regulation standards according to time slots of a day and the noise regulation standards according to regions.

The noise regulations may vary by region. In Korea, the noise regulation standards are set differently by each local government (city, county, district), and it may vary by the time slots of a day.

The noise regulations are generally separately applied by daytime and nighttime and vary depending on the time slot and the environment. In a case of the time-based noise regulations, sections may be divided into daytime and nighttime.

Daytime (6:00 AM to 10:00 PM) is a time slot in which noise levels are relatively permitted, while nighttime (10:00 PM to 6:00 AM) may be a time slot in which the noise regulations are in effect. The noise regulations may be strengthened in a night time slot as the noise regulations are applied for noises in residential areas (e.g., construction work, vehicle traffic, machinery noise, etc.).

For region-based noise standards, noise levels of 55 to 65 dB are permitted for residential regions, while the nighttime levels are limited to 50 dB or less. Commercial and industrial areas may have different noise standards and slightly higher noise levels than the residential area may be permitted.

The data reception module 170 may receive the time-based noise regulation information from the public institution server 700.

The processor 150 may determine the first time and the second time based on location information, which is information on the region where the air conditioning system 100 is installed, time-based electricity rate data, and time-based noise regulation information.

Specifically, the processor 150 may determine, based on the time-based electricity rate data and time-based noise regulation information, the first time as a time at which noise regulation ends during a day among times included in the lowest rate time slot in which the lowest electricity rate of a day is charged.

For example, when the lowest rate time slot in which the lowest electricity rate of a day is charged is the late-night time slot from 10:00 PM to 8:00 AM the next day, and the night time slot in which the noise regulations are in effect is from 10:00 PM to 6:00 AM the next day, the processor 150 may set 6:00 AM, the time at which the noise regulations end, as the first time among the times (10:00 PM to 8:00 AM the next day) included in the late-night time slot.

In this case, the second time may be 8:00 AM, which is the time at which the late-night time slot ends. In this case, the state of the air conditioning system 100 may be set to the second refrigerant cooling mode from 6:00 AM to 8:00 AM, but the method of setting the first time and the second time is not limited thereto.

The method of setting the first time and second time may be according to a predetermined algorithm, but may also be using an artificial intelligence model 191 that has been pre-trained by a machine learning method by considering predicted weather.

Machine learning refers to using a model composed of a plurality of parameters and optimizing the parameters based on given data. Depending on the type of learning materials, machine learning may include supervised learning, unsupervised learning, and reinforcement learning. Supervised learning refers to learning of a mapping between inputs and outputs and is applicable when input-output pairs are given as data. Unsupervised learning is applied when there are only inputs with no outputs and may identify patterns between inputs.

The machine learning module 180 may generate or train the artificial intelligence model 191 in various ways. For example, the machine learning module 180 may learn features extracted from learning data using a deep learning-based learning method.

In this case, in order to learn a method of extracting features from the learning data, a convolutional neural network (CNN) structure with multiple stages of convolution layers stacked may be utilized, but the learning method of the machine learning module 180 is not necessarily limited to a method that utilizes the CNN structure. For example, the learning method of the machine learning module 180 may be a method that involves machine learning algorithms including artificial neural network (ANN) or recurrent neural network (RNN).

A weather forecast server 800, which is a server managed by a weather forecast agency such as the Korea Meteorological Administration or the National Oceanic and Atmospheric Administration (NOAA) may store weather forecast information, which is prediction information on the weather.

The data reception module 170 may receive weather forecast information from the weather forecast server 800.

### THE PROCESSOR 150 MAY DETERMINE THE FIRST TIME AND THE SECOND TIME USING THE ARTIFICIAL INTELLIGENCE MODEL 191 BASED ON THE TIME-BASED ELECTRICITY RATE DATA TIME-BASED NOISE REGULATION INFORMATION AND WEATHER FORECAST INFORMATION

The pre-trained artificial intelligence model 191 may be stored in the memory 190. The artificial intelligence model 191 needs to be trained in advance through learning data for the first time and second time that were actually set in the learning stage.

In the learning stage, learning electricity rate data, which is data for electricity rate corresponding to a specific learning period, learning time-based noise regulation information, which is time-based noise regulation information corresponding to the learning period, and learning weather record information, which is weather record information corresponding to the learning period may be utilized as learning data. During the learning period corresponding to these learning data, the user may set the first and second times as a learning first time and a learning second time depending on purposes.

The machine learning module 180 may train the artificial intelligence model 191 through a machine learning method by setting the learning electricity rate data, the learning time-based noise regulation information, and the learning weather record information for a learning period among past periods as input variables, and by setting information of the learning first time and information on the learning second time that are set during the learning period as output variables.

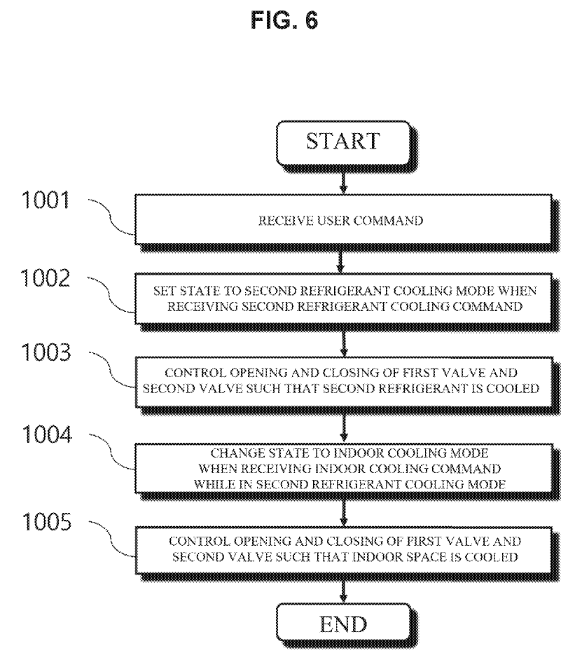

FIG. 6 is a flowchart of a method of controlling an air conditioning system according to an embodiment of the present disclosure. This is only an illustrated embodiment for achieving the purpose of the present disclosure, and some of configurations may be added or deleted as needed.

Referring to FIG. 6, the input module 160 may receive a user command (1001).

When the input module 160 receives a second refrigerant cooling command indicating to cool the second refrigerant, the processor 150 may set the state of the air conditioning system 100 to the second refrigerant cooling mode (1002).

When the state of the air conditioning system 100 is in the second refrigerant cooling mode, the processor 150 may control the opening and closing of the first valve 141 such that the first refrigerant of the first flow path 101 is delivered to the expansion valve 300, and may control the opening and closing of the second valve 142 such that the first refrigerant of the fourth flow path 104 is delivered to the second heat exchanger 132 (1003).

When the input module 160 receives an indoor cooling command indicating to cool the indoor space while the state of the air conditioning system 100 is in the second refrigerant cooling mode, the processor 150 may change the state of the air conditioning system 100 to the indoor cooling mode (1004).

When the state of the air conditioning system 100 is in the indoor cooling mode, the processor 150 may control the opening and closing of the first valve 141 such that the first refrigerant in the first flow path 101 is delivered to the first heat exchanger 131, and may control the opening and closing of the second valve 142 such that the first refrigerant of the fourth flow path 104 is delivered to the evaporator 400 (1005).

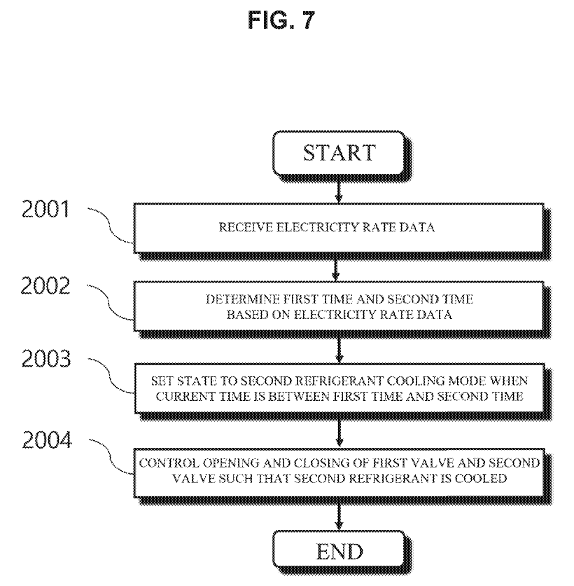

FIG. 7 is a flowchart of a method of controlling an air conditioning system for determining a time slot to be set to a second refrigerant cooling mode according to an embodiment of the present disclosure.

Referring to FIG. 7, the data reception module 170 may receive the time-based electricity rate data from the power supply company server 600 (2001).

The processor 150 may determine the first time and the second time based on the time-based electricity rate data (2002).

When the current time is between the first time and the second time of a day, the processor 150 may set the state of the air conditioning system 100 to the second refrigerant cooling mode (2003).

When the state of the air conditioning system 100 is in the second refrigerant cooling mode, the processor 150 may control the opening and closing of the first valve 141 such that the first refrigerant of the first flow path 101 is delivered to the expansion valve 300, and may control the opening and closing of the second valve 142 such that the first refrigerant of the fourth flow path 104 is delivered to the second heat exchanger 132 (2004).

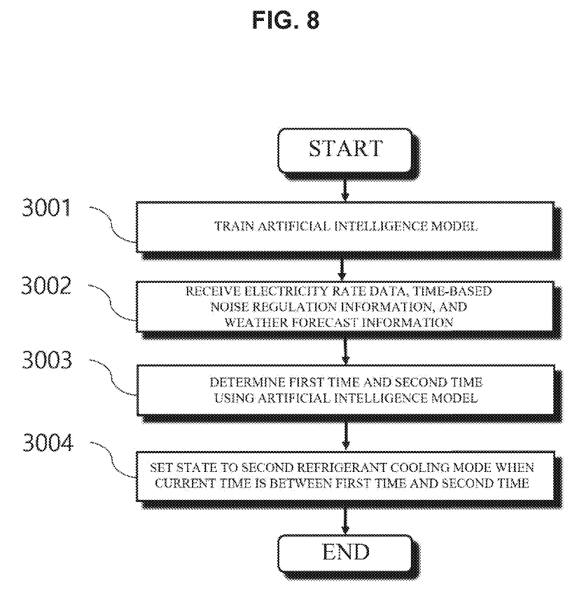

FIG. 8 is a flowchart of a method of controlling an air conditioning system for determining a time slot to be set to a second refrigerant cooling mode using an AI model according to an embodiment of the present disclosure.

Referring to FIG. 8, the machine learning module 180 may train the artificial intelligence model 191 through a machine learning method by setting the learning electricity rate data, the learning time-based noise regulation information, and the learning weather record information for a learning period among past periods as input variables, and by setting information of the learning first time and information on the learning second time that are set during the learning period as output variables (3001).

The data reception module 170 may receive the time-based electricity rate data from the power supply company server 600, the time-based noise regulation information from the public institution server 700, and the weather forecast information from the weather forecast server 800 (3002).

The processor 150 may determine the first time and the second time using the artificial intelligence model 191 based on the time-based electricity rate data, the time-based noise regulation information, and the weather forecast information (3003).

When the current time is between the first time and the second time during a day, the processor 150 may set the state of the air conditioning system 100 to the second refrigerant cooling mode (3004).

The input module 160, the data reception module 170, and the machine learning module 180 may include at least one processor 150 provided in the air conditioning system 100.

The method of controlling an air conditioning system 100 according to the embodiments of the present disclosure described above and those to be described later may be implemented in the form of a program executable by the processor 150.

The program may include program commands, data files, and data structures, either alone or in combination. The program may be designed and constructed using machine language codes or high-level language codes. The program may be specially designed to implement the method of controlling the air conditioning system 100 described above, or may be implemented using various functions or definitions that are already known and available to those skilled in the field of computer software. The program for implementing the above-described method of controlling the air conditioning system 100 may be recorded on a recording medium readable by the processor 150. In this case, the recording medium may be the memory 190.

The memory 190 may store a program that performs the operations described above and those to be described later, and the memory 190 may execute the stored program. In cases where the processor 150 and the memory 190 are provided in plural numbers, they may be integrated into a single chip or provided in physically separate locations. The memory 190 may include volatile memory such as Static Random Access Memory (S-RAM) and Dynamic Random Access Memory (D-RAM) for temporarily storing data. In addition, the memory 190 may include non-volatile memory such as Read Only Memory (ROM), Erasable Programmable Read Only Memory (EPROM), and Electrically Erasable Programmable Read Only Memory (EEPROM) for long-term storage of a control program and control data.

The processor 150 may include various logic circuits and arithmetic circuits, and may process data according to a program provided from the memory 190, and generate a control signal according to the processing result.

While the embodiments of the present disclosure have been described with reference to the illustrated embodiments, these are merely illustrative, and it will be understood by those skilled in the art that various alterations, variations, and equivalent other embodiments may be made without departing from the technical concepts and scope of the present disclosure. Therefore, the scope of the present disclosure should be defined by the technical concepts of the appended claims. Furthermore, the embodiments may be combined to form additional embodiments.

What is claimed is:

1. An air conditioning system configured to perform air conditioning by circulation of a first refrigerant, the air conditioning system comprising:
a thermally insulated tank configured to store a second refrigerant with a specific heat higher than that of the first refrigerant;
a first heat exchanger configured to perform heat exchange between the first refrigerant that is discharged by a condenser and the second refrigerant that is stored in the thermally insulated tank; and
a second heat exchanger configured to perform heat exchange between the first refrigerant that is discharged by an expansion valve and the second refrigerant that is stored in the thermally insulated tank

2. The air conditioning system of claim 1, wherein the first heat exchanger is configured to deliver the first refrigerant that is cooled by the second refrigerant to the expansion valve.

3. The air conditioning system of claim 1, wherein the second heat exchanger is configured to deliver the second refrigerant that is cooled by the first refrigerant to the thermally insulated tank and to deliver the first refrigerant of which temperature has increased to a compressor.

4. The air conditioning system of claim 1, further comprising at least one heat dissipation plate attached or connected to one side surface of the thermally insulated tank and configured to discharge heat of the thermally insulated tank to outside of the thermally insulated tank.

5. The air conditioning system of claim 1, further comprising:
a first flow path having one end connected to the condenser and configured to receive the first refrigerant from the condenser;
a second flow path having one end connected to the first heat exchanger and configured to deliver the first refrigerant to the first heat exchanger when receiving the first refrigerant from the first flow path; and
a third flow path having one end connected to the expansion valve and configured to deliver the first refrigerant to the expansion valve when receiving the first refrigerant from the first flow path.

6. The air conditioning system of claim 5, further comprising a first valve which is connected to one end of the first flow path, one end of the second flow path, and one end of the third flow path, and configured to deliver the first refrigerant received from the first flow path to one of the second flow path and the third flow path.

7. The air conditioning system of claim 6, further comprising:
a fourth flow path having one end connected to the expansion valve and configured to receive the first refrigerant from the expansion valve;
a fifth flow path having one end connected to the second heat exchanger and configured to deliver the first refrigerant to the second heat exchanger when receiving the first refrigerant from the fourth flow path; and
a sixth flow path having one end connected to an evaporator and configured to deliver the first refrigerant to the evaporator when receiving the first refrigerant from the fourth flow path.

8. The air conditioning system of claim 7, further comprising a second valve which is connected to one end of the fourth flow path, one end of the fifth flow path, and one end of the sixth flow path, and configured to deliver the first refrigerant received from the fourth flow path to one of the fifth flow path and the sixth flow path.

9. The air conditioning system of claim 8, further comprising a processor configured to control opening and closing of the first valve and opening and closing of the second valve,
wherein the processor is configured to control the opening and closing of the first valve such that the first refrigerant of the first flow path is delivered to one of the first heat exchanger and the expansion valve, and
to control the opening and closing of the second valve such that the first refrigerant of the fourth flow path is delivered to one of the second heat exchanger and the evaporator.

10. The air conditioning system of claim 9, wherein the processor is configured to
control the opening and closing of the first valve such that the first refrigerant of the first flow path is delivered to the expansion valve when a state of the air conditioning system is in a second refrigerant cooling mode,
to control the opening and closing of the second valve such that the first refrigerant of the fourth flow path is delivered to the second heat exchanger when the state of the air conditioning system is in the second refrigerant cooling mode,
to control the opening and closing of the first valve such that the first refrigerant of the first flow path is delivered to the first heat exchanger when the state of the air conditioning system is in an indoor cooling mode, and
to control the opening and closing of the second valve such that the first refrigerant of the fourth flow path is delivered to the evaporator when the state of the air conditioning system is in the indoor cooling mode.

11. The air conditioning system of claim 10, further comprising an input module configured to receive a user command,
wherein the processor is configured to set the state of the air conditioning system to the second refrigerant cooling mode when the input module receives a second refrigerant cooling command indicating to cool the second refrigerant.

12. The air conditioning system of claim 10, further comprising an input module configured to receive a user command,
wherein the processor is configured to change the state of the air conditioning system to the indoor cooling mode when the input module receives an indoor cooling command indicating to cool the indoor space while the state of the air conditioning system is in the second refrigerant cooling mode.

13. The air conditioning system of claim 10, wherein the processor is configured to set the state of the air conditioning system to the second refrigerant cooling mode when a current time is between a first time, which is one time of a day, and a second time, which is later than the first time.

14. The air conditioning system of claim 13, further comprising a data reception module configured to receive time-based electricity rate data including information on electricity rates depending on time slots of the day from a power supply company server,
wherein the processor is configured to determine the first time and the second time based on the time-based electricity rate data.

15. The air conditioning system of claim 14, wherein the processor is configured to determine, based on the time-based electricity rate data, the first time as a time at which a lowest rate time slot, in which a lowest electricity rate of a day is charged, starts, and to determine the second time as a time at which the lowest rate time slot ends, and
when the data reception module receives updated time-based electricity rate data, to change the first time to a time at which an updated lowest rate time slot starts and to change the second time to a time at which the updated lowest rate time slot ends based on the updated time-based electricity rate data.

16. The air conditioning system of claim 14, wherein the processor is configured to determine whether the electricity rate for a current time is less than a preset reference rate based on the time-based electricity rate data, and
to set a state of the air conditioning system to a second refrigerant cooling mode when the electricity rate for the current time is less than the reference rate.

17. The air conditioning system of claim 14, wherein the data reception module is configured to receive time-based noise regulation information which includes information on noise regulation standards according to time slots of a day and the noise regulation standards according to regions from a public institution server,
wherein the processor is configured to determine the first time and the second time based on location information which is information on a region where the air conditioning system is installed, the time-based electricity rate data, and the time-based noise regulation information.

18. The air conditioning system of claim 17, wherein the processor is configured to determine, based on the time-based electricity rate data and the time-based noise regulation information, the first time as a time at which the noise regulation ends during a day among times included in a lowest rate time slot in which the lowest electricity rate of a day is charged.

19. The air conditioning system of claim 17, wherein the data reception module is configured to receive weather forecast information, which is prediction information on weather, from a weather forecast server, and
the processor is configured to determine the first time and the second time using an artificial intelligence model based on the time-based electricity rate data, the time-based noise regulation information, and the weather forecast information, and
further comprising a machine learning module configured to train the artificial intelligence model through a machine learning method by setting learning electricity rate data, learning time-based noise regulation information, and learning weather record information for a learning period among past periods as input variables, and by setting information on a learning first time and information on a learning second time that are set during the learning period as output variables.

20. A method of controlling an air conditioning system to control the air conditioning system according to claim 9, the method comprising:
controlling, by the processor, the opening and closing of the first valve such that the first refrigerant of the first flow path is delivered to one of the first heat exchanger and the expansion valve; and
controlling, by the processor, the opening and closing of the second valve such that the first refrigerant of the fourth flow path is delivered to one of the second heat exchanger and the evaporator,
wherein the controlling of the opening and closing of the first valve and the controlling of the opening and closing of the second valve comprise:
controlling, by the processor, the opening and closing of the first valve such that the first refrigerant of the first flow path is delivered to the expansion valve when a state of the air conditioning system is in a second refrigerant cooling mode;
controlling, by the processor, the opening and closing of the second valve such that the first refrigerant of the fourth flow path is delivered to the second heat exchanger when the state of the air conditioning system is in the second refrigerant cooling mode;
controlling, by the processor, the opening and closing of the first valve such that the first refrigerant of the first flow path is delivered to the first heat exchanger when the state of the air conditioning system is in an indoor cooling mode; and
controlling, by the processor, the opening and closing of the second valve such that the first refrigerant of the fourth flow path is delivered to the evaporator when the state of the air conditioning system is in the indoor cooling mode.

21. An air conditioning system configured to perform cooling via circulation of a first refrigerant, the air conditioning system comprising:
a thermally insulated tank containing a liquid phase second refrigerant having a specific heat higher than a specific heat of the first refrigerant;
a first heat exchanger fluidly coupled to a condenser, the first heat exchanger configured to cool the first refrigerant by transferring heat from the first refrigerant to the second refrigerant; and
a second heat exchanger fluidly coupled to an evaporator, the second heat exchanger configured to pre-cool the second refrigerant by transferring heat from the second refrigerant to the first refrigerant during an off-peak electricity rate period; and
a processor configured to selectively activate the second heat exchanger to cool the second refrigerant based on a time-of-use electricity schedule and a noise regulation schedule associated with a location of the air conditioning system.
